(19) United States
(12) Patent Application Publication
(10) Pub. No.: US 2021/0405701 A1
(43) Pub. Date: Dec. 30, 2021

(54) DOCKABLE APPARATUS FOR AUTOMATICALLY-INITIATED CONTROL OF EXTERNAL DEVICES

(71) Applicant: ROBBOX INC., Richmond (CA)

(72) Inventor: Andrei MATEI, Coquitlam (CA)

(73) Assignee: ROBBOX INC., Richmond (CA)

(21) Appl. No.: 17/364,795

(22) Filed: Jun. 30, 2021

Related U.S. Application Data
(60) Provisional application No. 63/046,552, filed on Jun. 30, 2020.

(51) Int. Cl. G06F 1/16; H04B 5/00; G06F 8/65

(52) U.S. Cl. CPC G06F 1/1632; G06F 8/65; H04B 5/0031

(57) ABSTRACT

An apparatus including a display, an antenna, and processing circuitry that receives, via the antenna, a near-field communication data packet from an antenna of a secondary device, the near-field communication data packet including information regarding a functional type of the secondary device, and updates graphics of the display based on the functional type of the secondary device.

### CROSS-REFERENCE TO RELATED APPLICATIONS

This application claims priority to U.S. Provisional Application 63/046,552, filed Jun. 30, 2020, herein incorporated by reference.

### SUMMARY

The present disclosure describes a dockable apparatus for automatically-initiated control of external devices. The dockable apparatus may be a unified display and control module that can be docked or integrated with a variety of end effectors. This allows the dockable apparatus to control the variety of end effectors, or external devices, without the need to be integrated therein. This makes it possible to avoid incorporation of complex hardware and software systems into each external device. The display and control module may be referred to herein as a dockable display and control module (DDCM). The DDCM may include a partial or a complete system that can serve as a display for and control an external device. The DDCM provides an operator with a visual aid for controlling and monitoring other devices. The DDCM is a handheld, wearable, or attachable device that allows a user to easily and intuitively interact with a combination of integrated internal sensors and secondary external devices simultaneously, in real time. The DDCM can coordinate the operation of secondary devices through a combination of user input or integrated sensors. The DDCM can also control and change the status of other devices through changes to its own sensors. The DDCM can provide a visual aid to the operator of the status of the DDCM and also the status of secondary devices. The DDCM can provide the ability to control sensors integrated into the DDCM and sensors in other devices through a single unified screen. The DDCM can change the status (display and control) of other devices automatically through changing the status of its own internal sensors The DDCM consists of a display, processor, internal memory, user input components, user feedback components, integrated sensors, communication devices, and integrated power supply components. The DDCM will be described in detail below.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is an illustration of an assembled view of a device, according to an exemplary embodiment of the present disclosure;

FIG. 1B is an illustration of an exploded view of a device, according to an exemplary embodiment of the present disclosure;

FIG. 2A is an illustration of an assembled view of a rectangular configuration of a device, according to an exemplary embodiment of the present disclosure;

FIG. 2B is an illustration of an exploded view of a rectangular configuration of a device, according to an exemplary embodiment of the present disclosure;

FIG. 3A is an illustration of an assembled view of a circular configuration of a device, according to an exemplary embodiment of the present disclosure;

FIG. 3B is an illustration of an exploded view of a circular configuration of a device, according to an exemplary embodiment of the present disclosure;

FIG. 4A is an illustration of an assembled view of a square configuration of a device, according to an exemplary embodiment of the present disclosure;

FIG. 4B is an illustration of an exploded view of a square configuration of a device, according to an exemplary embodiment of the present disclosure;

FIG. 5 is an illustration of a device arranged on a window for use within a home monitoring service, according to an exemplary embodiment of the present disclosure;

FIG. 6 is an illustration of a device wirelessly connected to multiple secondary devices, according to an exemplary embodiment of the present disclosure;

FIG. 7A is an illustration of a docked device wirelessly connected to multiple secondary devices, according to an exemplary embodiment of the present disclosure;

FIG. 7B is an illustration of a docked device wirelessly connected to multiple secondary devices, according to an exemplary embodiment of the present disclosure;

FIG. 8 is an illustration of a device connected to a wrist wearable dock, according to an exemplary embodiment of the present disclosure;

FIG. 9 is an illustration of a device connected to a neck wearable dock, according to an exemplary embodiment of the present disclosure;

FIG. 10 is an illustration of a device docking to a tool with mechanical mount, according to an exemplary embodiment of the present disclosure;

FIG. 11 is an illustration of multiple devices connected back to back, according to an exemplary embodiment of the present disclosure;

FIG. 12 is an illustration of multiple devices connected in a multi-port dock, according to an exemplary embodiment of the present disclosure;

FIG. 13 is an illustration of a device implemented within a vehicular environment, according to an exemplary embodiment of the present disclosure;

FIG. 14A is an illustration of a device connected to a combination laser level, according to an exemplary embodiment of the present disclosure;

FIG. 14B is a flow diagram of a method of a device connected to a combination laser level, according to an exemplary embodiment of the present disclosure;

FIG. 14C is an illustration of a flow diagram of a method of a device connected to a combination laser level, according to an exemplary embodiment of the present disclosure;

FIG. 14D is a flow diagram of a method of a device connected to a combination laser level, according to an exemplary embodiment of the present disclosure;

FIG. 14E is an illustration of a flow diagram of a method of a device connected to a combination laser level, according to an exemplary embodiment of the present disclosure;

FIG. 15A is an illustration of a display of a device connected to a combination level and one or more inertial measurement units, according to an exemplary embodiment of the present disclosure;

FIG. 15B is an illustration of a display of a device connected to a combination level and one or more inertial measurement units, according to an exemplary embodiment of the present disclosure;

FIG. 15C is an illustration of a display of a device connected to a combination level and one or more inertial measurement units, according to an exemplary embodiment of the present disclosure;

FIG. 16A is an illustration of a display of a device connected to a combination level, one or more inertial measurement units, and antennas, according to an exemplary embodiment of the present disclosure;

FIG. 16B is an illustration of a display of a device connected to a combination level, one or more inertial measurement units, and antennas, according to an exemplary embodiment of the present disclosure;

FIG. 16C is an illustration of a display of a device connected to a combination level, one or more inertial measurement units, and antennas, according to an exemplary embodiment of live present disclosure;

FIG. 16D is an illustration of a display of a device connected to a combination level, one or more inertial measurement units, and antennas, according to an exemplary embodiment of the present disclosure;

FIG. 16E is an illustration of a display of a device connected to a combination level, one or more inertial measurement units, and antennas, according to an exemplary embodiment of the present disclosure;

FIG. 17A is an illustration of a device connected to a stud finder including lasers and antennas, according to an exemplary embodiment of the present disclosure;

FIG. 17B is an illustration of a display of a device connected to a stud finder including lasers and antennas, according to an exemplary embodiment of the present disclosure;

FIG. 17C is an illustration of a display of a device connected to a stud finder including lasers and antennas, according to an exemplary embodiment of the present disclosure;

FIG. 17D is an illustration of a display of a device connected to a stud finder including lasers and antennas, according to an exemplary embodiment of the present disclosure;

FIG. 17E is an illustration of a display of a device connected to a stud finder including lasers and antennas, according to an exemplary embodiment of the present disclosure;

FIG. 17F is an illustration of a display of a device connected to a stud finder including lasers and antennas, according to an exemplary embodiment of the present disclosure;

FIG. 18A is an illustration of a display of a device including inertial measurement units, according to an exemplary embodiment of the present disclosure;

FIG. 18B is an illustration of a display of a device including inertial measurement units, according to an exemplary embodiment of the present disclosure;

FIG. 18C is an illustration of a display of a device including inertial measurement units, according to an exemplary embodiment of the present disclosure;

FIG. 19A is an illustration of a device implementing wrist watch detection via antenna, according to an exemplary embodiment of the present disclosure;

FIG. 19B is an illustration of a device implementing wrist watch detection via antenna and adjusting display, according to an exemplary embodiment of the present disclosure;

FIG. 20A is an illustration of a display of a device for control, display, matching, tracking, and comparing using a camera and other sensors, according to an exemplary embodiment of the present disclosure;

FIG. 20B is an illustration of a display of a device for control, display, matching, tracking, and comparing using a camera and other sensors, according to an exemplary embodiment of the present disclosure;

FIG. 20C is an illustration of a display of a device for control, display, matching, tracking, and comparing using a camera and other sensors, according to an exemplary embodiment of the present disclosure;

FIG. 20D is an illustration of a display of a device for control, display, matching, tracking, and comparing using a camera and other sensors, according to an exemplary embodiment of the present disclosure;

FIG. 20E is an illustration of a display of a device for control, display, matching, tracking, and comparing using a camera and other sensors, according to an exemplary embodiment of the present disclosure;

FIG. 20F is an illustration of a display of a device for control, display, matching, tracking, and comparing using a camera and other sensors, according to an exemplary embodiment of the present disclosure;

FIG. 20G is an illustration of a display of a device for control, display, matching, tracking, and comparing using a camera and other sensors, according to an exemplary embodiment of the present disclosure;

FIG. 20H is an illustration of a display of a device for control, display, matching, tracking, and comparing using a camera and other sensors, according to an exemplary embodiment of the present disclosure;

FIG. 20I is an illustration of a display of a device for control, display, matching, tracking, and comparing using a camera and other sensors, according to an exemplary embodiment of the present disclosure;

FIG. 20J is an illustration of a display of a device for control, display, matching, tracking, and comparing using a camera and other sensors, according to an exemplary embodiment of the present disclosure;

FIG. 21 is an illustration of a display of a device for control and display of motor speeds an torques on one of multiple devices, according to an exemplary embodiment of the present disclosure;

FIG. 22 is an illustration of a display of a device during uploading and updating via wireless communication or hard wire connection, according to an exemplary embodiment of the present disclosure;

FIG. 23 is an illustration of a device connected to a vacuum cleaner, according to an exemplary embodiment of the present disclosure;

FIG. 24A is an illustration of a door having a lock, according to an exemplary embodiment of the present disclosure;

FIG. 24B is an illustration of a device connected to a door having a lock in a locked state, according to an exemplary embodiment of the present disclosure;

FIG. 24C is an illustration of a device connected to a door having a lock in an unlocked state, according to an exemplary embodiment of the present disclosure;

FIG. 25 is an illustration of a device connected to a secondary device and in control of a battery, thereof, according to an exemplary embodiment of the present disclosure;

FIG. 26 is an illustration of devices connected to an airplane, according to an exemplary embodiment of the present disclosure;

FIG. 27 is an illustration of devices connected to a robot in a robotic application, according to an exemplary embodiment of the present disclosure;

FIG. 28 is an illustration of devices connected to a flying machine, such as a drone, according to an exemplary embodiment of the present disclosure;

FIG. 29 is an illustration of application-specific software that can be accessed via cloud-computing environment according to an exemplary embodiment of the present disclosure; and

FIG. 30 is a schematic of a hardware configuration of a device, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, live appearances of such phrases or in various places throughout this specification arc not necessarily all referring to the same embodiment. Furthermore, the particular features, structures, or characteristics may be combined in any suitable manner in one or more embodiments without limitation.

According to an embodiment, the controller module may be configured to be docked to a variety of end effectors, tools, jewelry, gadgets, and the like The controller module, accordingly, may be referred to hereinafter as a multi-docking controller module (DDCM). The DDCM may be multi-functional in order to provide a user with a range of configuration options. For instance, the DDCM allows users to: (1) interact with the DDCM using a display controlled through a touch interface, buttons, sliders, dials, and the like, (2) interact with data collected from sensors and components integrated into the DDCM, (3) control secondary devices such as power tools, motors, tools, monitors, apparatus, equipment, computers, phones, other DDCMs, and the like, (4) monitor, utilize, store, share, and transmit data collected from secondary devices, (5) provide a user with updates, status, alerts, warnings, and errors collected from internal components and secondary devices, and (6) control torque and speed of motors in other tools, power tools, devices, equipment, and machinery.

Further, the DDCM has the ability to connect either physically or wirelessly to secondary devices, thereby allowing a user to transfer data from the DDCM to the secondary device, transfer data from the secondary device to the DDCM, control the secondary device, provide visual feedback to a user on the status of the secondary device, automatically configure a secondary device, automatically load configurations or control menus for the secondary device onto the DDCM upon connection thereto, collect data from secondary device in the form of information, data, status, images, video, links, ids, time, dates, coordinates, alerts, warnings, and the like, identify a current user of the secondary device through the DDCM, and automatically configure the secondary device with information stored in the DDCM in the form of settings, preferences, configurations, presets, history, and the like.

According to an embodiment, the DDCM can be paired with multiple secondary devices, including other DDCMs, through mechanical means, magnetic means, wireless means, and/or other forms of connections. For instance, the connection to transfer data between the DDCM and the secondary device can be accomplished through (1) a physical electrical connection in the form of a connector, bus, interface, plug, socket, electrical contact, or any other medium for electrical data transfer, and (2) a wireless connection in the form of Wi-Fi, Bluetooth, near-field communication (NFC), ZigBee, LoRa, or any other electromagnetic based wireless communication method. The DDCM can also be physically connected to die secondary device in order to: (1) position the display in a convenient location for visual feedback for die user, (2) display, monitor, and control secondary devices, (3) secure the DDCM during operation of the secondary device, (4) use the DDCM as a key to unlock/enable the secondary device, (5) allow initiation of wireless communication between the DDCM and the secondary device, and (6) ensure correct identification of the desired secondary device. Additionally, the DDCM can connect to a local or remote server or computer for the purpose of storing, saving, backing up, or restoring data collected by the DDCM, updating, replacing, upgrading, or improving DDCM software, and reporting, documenting, logging, or tracking DDCM usage

According to an embodiment, the DDCM can be a small to medium size device that is handheld and used carried, worn, or attached on another power tool, device, or apparatus through a mechanical, magnetic, or other attachment system. In an embodiment, as will be described with reference to the Figures, the DDCM may be a fully enclosed device that can incorporate an interactive touch screen or display screen microcontroller and other electronics.

According to an embodiment, the DDCM may be outfitted with a variety of sensors and measurement devices that can be customized for a specific application. The DDCM can incorporate sensors such as laser(s), accelerometer(s), magnetometer(s), gyroscope(s), RFID tag(s)/reader(s), camera(s), stud finder(s), microphone(s), temperature sensor(s), pressure sensor(s), humidity sensor(s), carbon dioxide and/or carbon monoxide sensor(s) (or other gas sensor(s)), Global Positioning System (GPS) receiver(s), microphone(s), multimeter(s), magnetic sensor(s), and other electronic sensors.

According to an embodiment, the DDCM can provide feedback to a user during operation or use in a variety of forms. To this end, the DDCM can incorporate a variety of feedback devices including screen(s), display(s), speaker(s), haptic device(s), buzzer(s), alarm(s), light(s) such as light emitting diodes (LEDs), and the like. The display(s) and other feedback devices can provide the user with feedback in the form of notifications, messages, a heads up display (HUD), icons, measurements, graphs, images, video, data, updates, settings, configuration, alerts, warnings, indications, and the like. In an embodiment, the user can interact with the DDCM using a variety of methods including touch control (capacitive, resistive, and the like), buttons, sliders, dials, rotating bezels, switches, voice control, motion gestures, movement of the device, location of the DDCM, and the like. According to a specific application determined automatically, the user will be provided with flexible input options using the display in the form of menus, lists, widgets, sliders, scroll wheels, buttons, windows, drop-down, pop-ups, notifications, alerts, and the like.

According to an embodiment, the DDCM includes processing circuitry configured to execute instructions defined by software. The software of the DDCM provides the following benefits: (1) an operating system, either real-time or not, that coordinates tasks or functions to be completed by the device, (2) modular software libraries or applications that allow the user to configure, or customize, the DDCM for their use case, (3) a means to update the software, or firmware, on the DDCM, either wirelessly or wired, that is initiated either locally or remotely, (4) a graphical user interface that offers dynamic interaction options for the user using a display, (5) display interactions that can be updated automatically by the device or by the user, and (6) security and encryption, implemented in software or a hardware device, to protect sensitive information on, or transmitted by, the device.

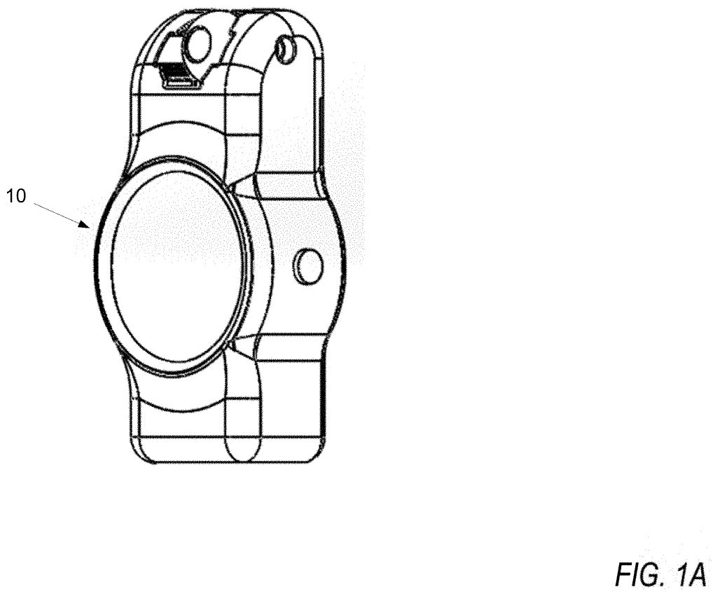

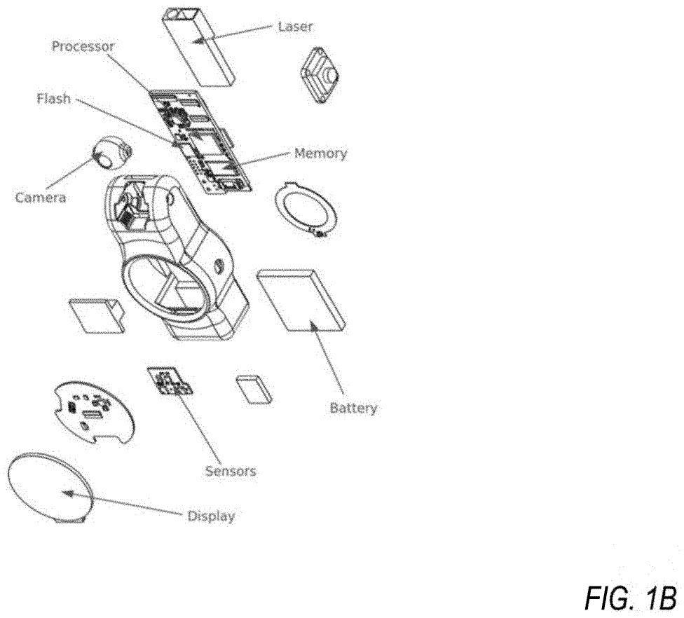

According to an embodiment, a DDCM may include a custom housing design with a display 10 that is substantially circular, as shown in FIG. 1A. The DDCM configuration of FIG. 1A, wherein the display 10 is a circular display, or a round display, may further include a processor(s), a memory(s), a flash(s), a display(s), a camera(s), a laser(s), and a sensor board(s), among others. While FIG. 1A illustrates an assembled view of the DDCM according to a specific configuration, FIG. 1B provides an exploded view of the DDCM, wherein each of the components thereof arc identified in view of the above.

In an embodiment, the DDCM configuration of FIG. 1A and FIG. 1B can be connected to a multi-measuring device that can record video, scan and perform other applications. In connection with the multi-measuring device, the DDCM configuration can be used as a camera alone or in combination with one or more sensors including a laser measuring device, long and near field communication antenna, and inertial measurement unit.

In an embodiment, the DDCM configuration of FIG. 1A and FIG. 1B can be a wearable device, an independent device, a dockable device, or can be physically integrated with the one or more external devices.

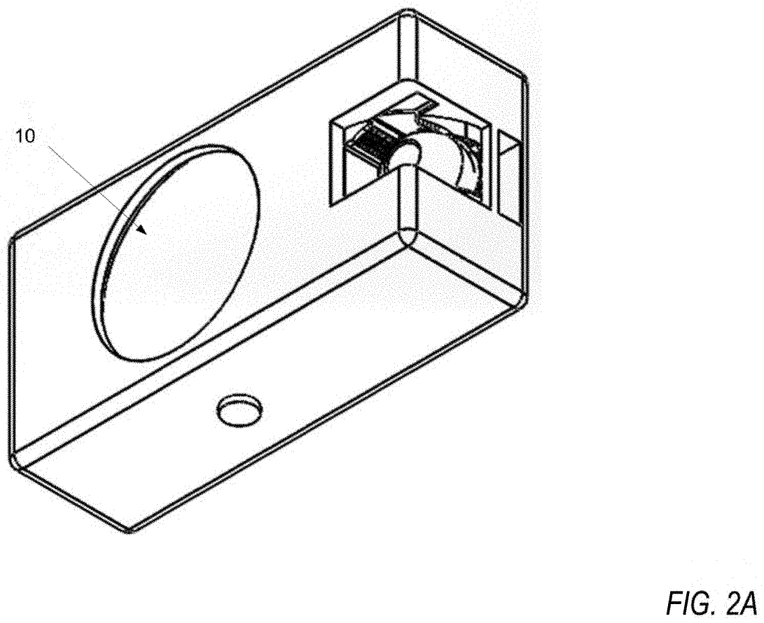

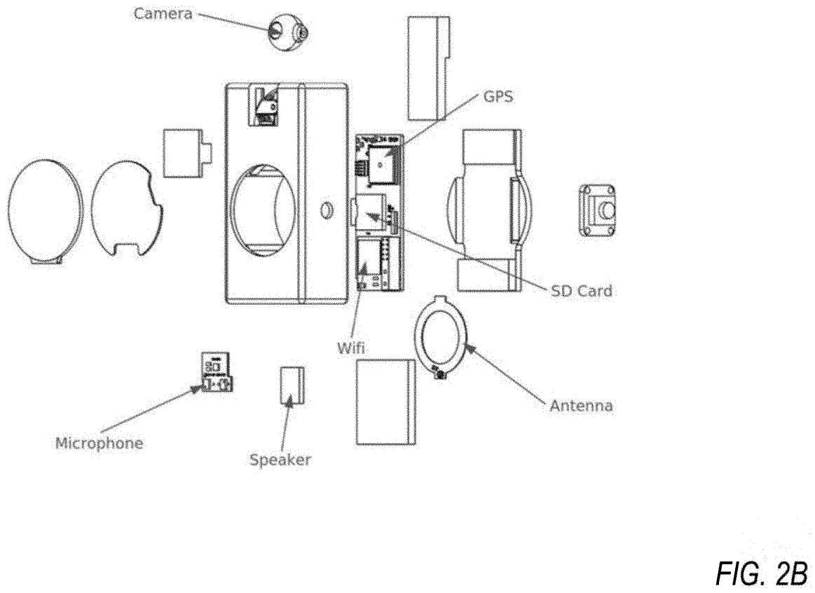

According to an embodiment, a DDCM may include a custom housing design with a display 10 that is substantially circular, as shown in FIG. 2A. The custom housing design of the DDCM configuration of FIG. 2A may be substantially rectangular and may further include a camera(s), a GPS receiver(s), an SD card(s), Wi-Fi, a microphone(s), a speaker(s), and an antenna(s), among others. While FIG. 2A illustrates an assembled view of the DDCM according to a specific configuration, FIG. 2B provides an exploded view of the DDCM, wherein each of the components thereof are identified in view of the above.

In an embodiment, the DDCM configuration of FIG. 2A and FIG. 2B can be a wearable device, an independent device, a dockable device, or can be physically integrated with the one or more external devices.

In an embodiment, the DDCM configuration of FIG. 2A and FIG. 2B can be used to control an autonomous vehicle, a semi-autonomous vehicle, a vehicle, or another robotic application. In an embodiment, the DDCM configuration may include sensors and instruments for vision systems and GPS locations to detect obstacles and provide location/position to drive systems and in order to control different applications that may be a distance away from the control panel.

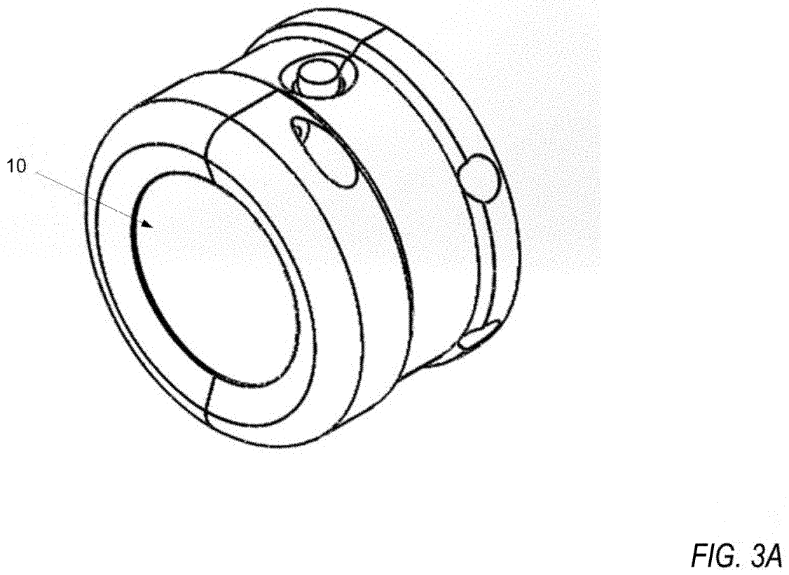

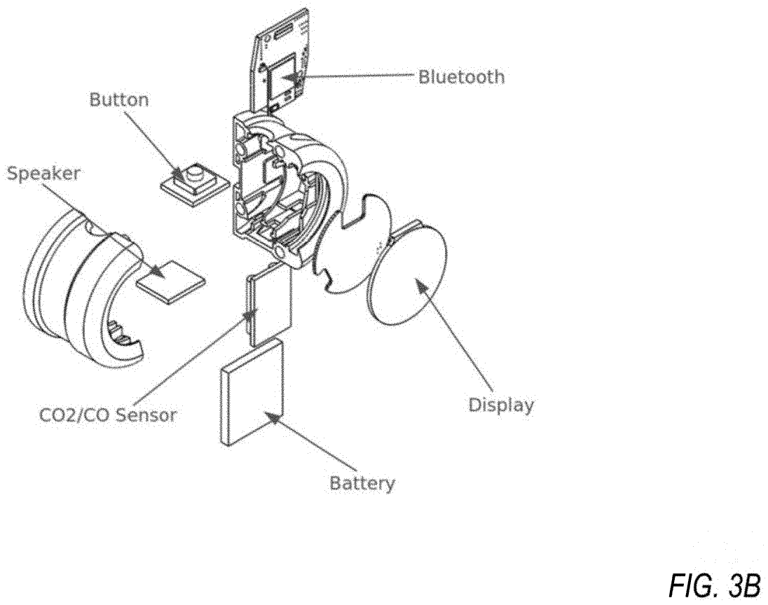

According to an embodiment, a DDCM may include a custom housing design with a display 10 that is substantially circular, as shown in FIG. 3A. The custom housing design of the DDCM configuration of FIG. 3A may be substantially cylindrical, providing a more compact form factor, and may further include Bluetooth, a button(s), a speaker(s), a carbon dioxide sensor(s), a carbon monoxide sensor(s), and a battery(s). While FIG. 3A illustrates an assembled view of the DDCM according to a specific configuration, FIG. 3B provides an exploded view of the DDCM, wherein each of the components thereof are identified in view of the above.

In an embodiment, the DDCM configuration of FIG. 3A and FIG. 3B can be a wearable device, an independent device, a dockable device, or can be physically integrated with the one or more external devices.

In an embodiment, the DDCM configuration of FIG. 3A and FIG. 3B can be implemented within a medical or other industrial field application device. For instance, the DDCM configuration can be used to measure carbon levels and make changes of status of its own sensors and other remote apparatuses confirming with the carbon levels.

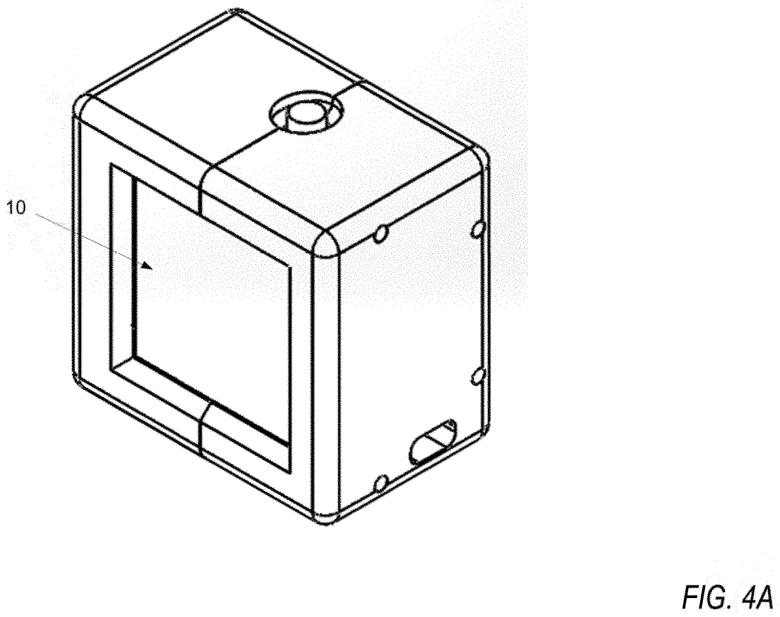

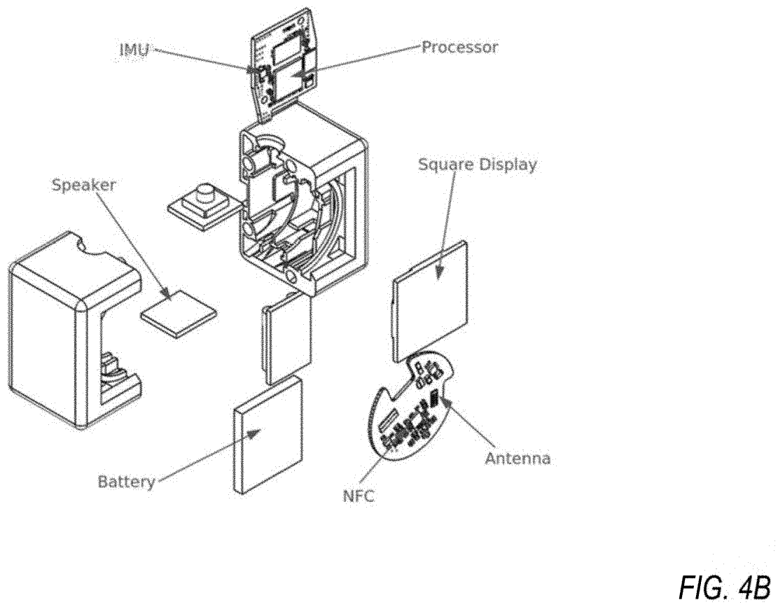

According to an embodiment, a DDCM may include a custom housing design with a display 10 that is substantially rectangular, as shown in FIG. 4A. The custom housing design of the DDCM configuration of FIG. 4A may be substantially rectangular and may further include a processor(s), an inertial measurement unit(s), a speaker(s), a battery(s), near-field communication systems, and an antenna(s), among others. While FIG. 4A illustrates an assembled view of the DDCM according to a specific configuration, FIG. 4B provides an exploded view of the DDCM, wherein each of the components thereof are identified in view of the above.

In an embodiment, the DDCM configuration of FIG. 4A and FIG. 4B can be a wearable device, an independent device, a dockable device, or can be physically integrated with the one or more external devices.

In an embodiment, the DDCM configuration of FIG. 4A and FIG. 4B can be used to control a flying object such as airplane, drone, or other airborne machinery or apparatus. One or more DDCMs can be connected to a flying object and can be configured to sense and control the objects from a built in software program or wirelessly-transmitted command.

The above described and similar configurations of a DDCM will now be described with respect to specific implementation environments.

According to an embodiment, a DDCM may be employed in the home to interact with the environment, using a range of onboard sensors, and secondary devices in the home. Such home automation can include: (1) environmental monitoring (e.g., temperature, humidity, pressure, air quality), (2) controlling home environment as a thermostat, (3), controlling configuring and scheduling equipment (e.g., pool pump, sprinklers), (4) connecting to and controlling smart devices (e.g., light bulbs, smart plugs), and (5) security detection using a camera and alerts. For instance, as in FIG. 5, the DDCM may be a window mounted DDCM in order to provide home monitoring services.

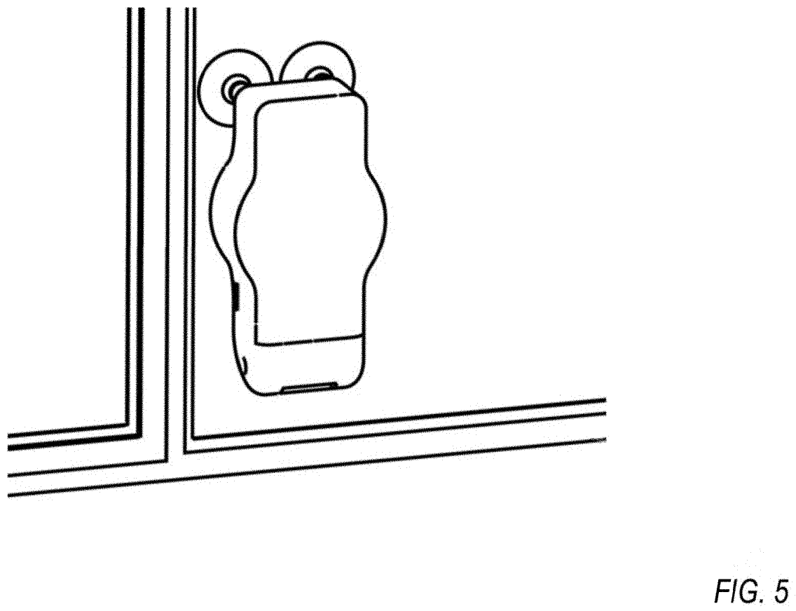

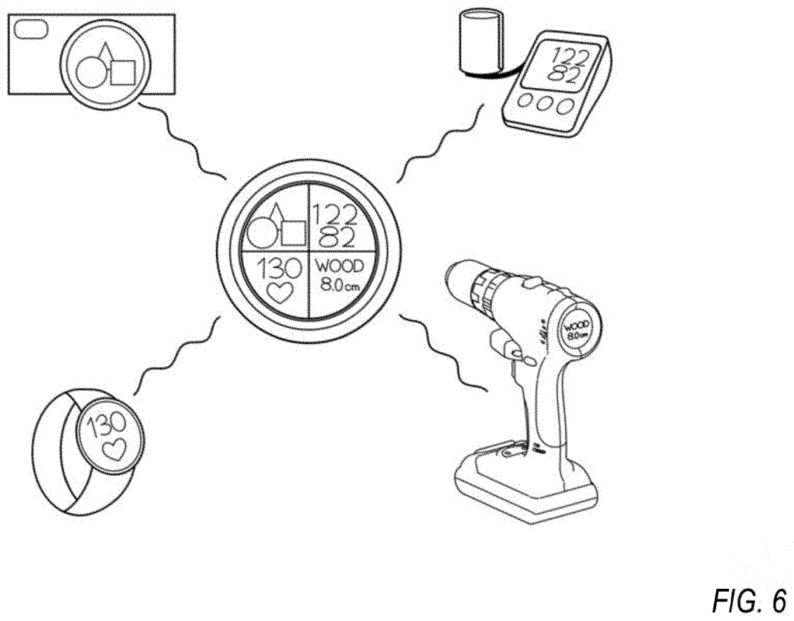

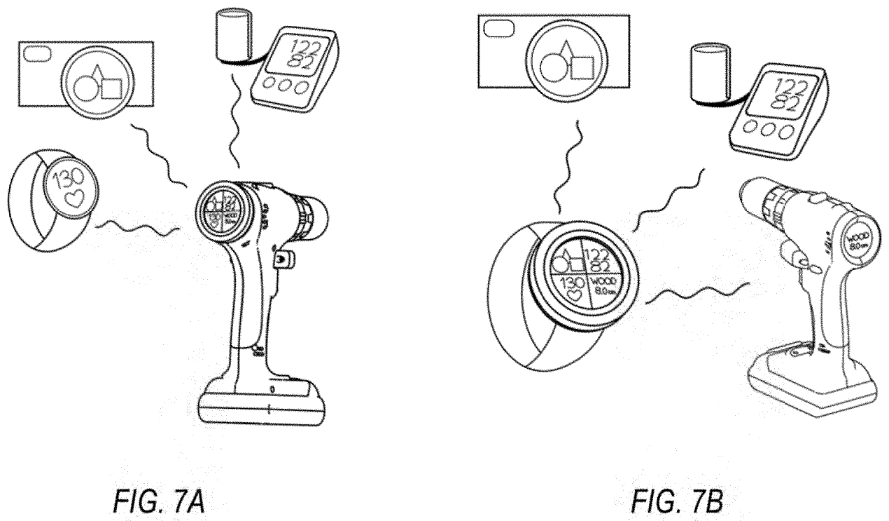

According to an embodiment, a DDCM may be employed in an industrial environment to coordinate, collect, transfer, and store data generated by equipment, or secondary devices, as shown in FIG. 6, FIG. 7A, and FIG. 7B. To this end, the DDCM may enable to a user to: (1) track tool data including location, usage, measurements, or wear, (2) aggregate data in a central location, (3) access information from a previous work session, (4) monitor and track job progress for time management and billing purposes, and (5) track run time and power usage for machinery using onboard sensors (e.g., multimeters), magnetic sensor(s)). As shown in FIG. 6, the DDCM may be wirelessly connected to multiple secondary devices in order to monitor and control the secondary devices. This can include controlling multiple applications as well as importing, exporting, and data transfer from various devices, tools, and apparatuses. As shown in FIG. 7A and FIG. 7B, the DDCM may be docked to one of the multiple secondary devices while still monitoring and controlling each of the multiple secondary devices.

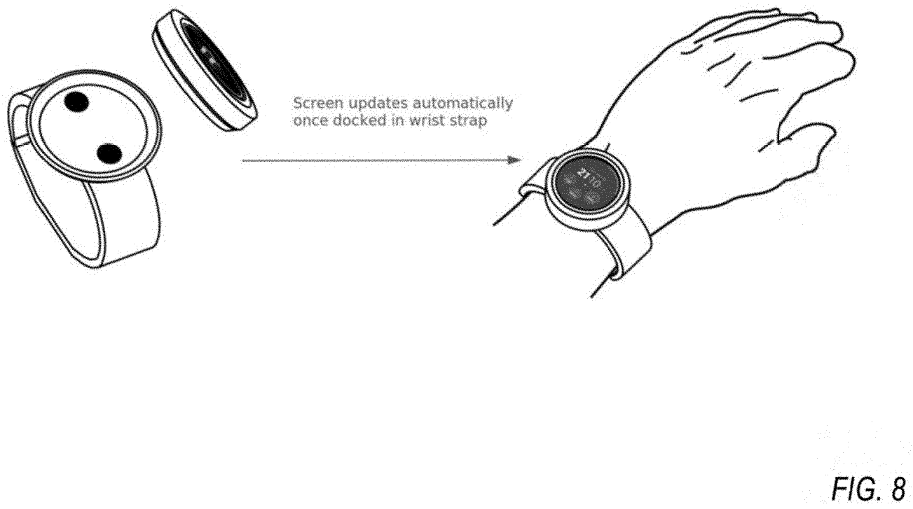

According to an embodiment, a DDCM may be employed in hospital settings for monitoring and tracking of patient information. For instance, the DDCM may be used by nurses to provide alerts for critical patient care or reminders for time sensitive duties. Further, the DDCM may be used by surgeons during operations to track patient vital signs or tool or equipment function or status (e.g., tool position, tool speed, fluid flow rate). In an embodiment, the DDCM may interact with distributed sensors in tools and equipment, aggregate darn collected from operating theaters or hospital sensors into a single display, monitor critical vital signs and provide alerts in real time, allow convenient device location in a wearable format, and provide timely alerts, notifications, or reminders with feedback devices. The above would be enabled by the DDCM displayed in FIG. 8, wherein an DDCM is docked to a wrist wearable docking station, the wrist wearable docking station allowing the DDCM to function in the above described capacities.

According to an embodiment, a DDCM may be customized for a personal safety monitoring device. The DDCM may be configured to detect unsafe conditions and alert a user. The DDCM may also be configured to connect to a remote server through wireless communication in order to alert a third party of an emergency and a location thereof. In an embodiment, the DDCM may be used, as shown in FIG. 9 connected to a neck wearable dock, by the elderly for fall detection or panic alert, by miners or construction workers as a gaseous sensor, by office workers for building alerts (e.g., personalized fire alarm integrated with building services), and by parents of young children or pet owners for geo fencing and location tracking.

According to an embodiment, a DDCM may be used independently as a standalone measurement device. For instance, an electrician may use the DDCM, in a customized module, in a range of applications including as a camera to scan and store a barcode or other visual identifying code (e.g., QR, AprilTag), as a NFC ID tag for easy labelling of electrical outlet and circuit breaker pairings, as an electrical current sensor to alert a user to live wires, as a magnetic sensor to detect a type of metal, as a stud finder to indicate a location of wall studs, and as a laser measurement tool to measure, store, and use the dimension of rooms for planning.

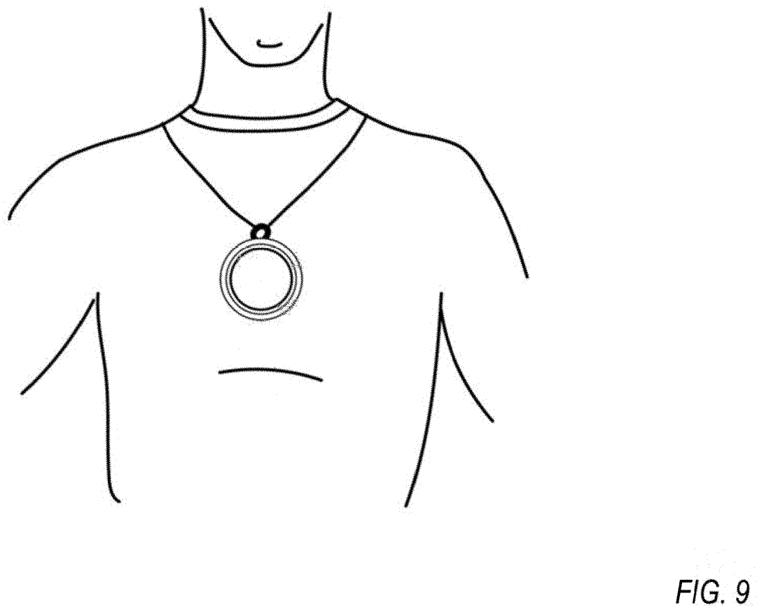

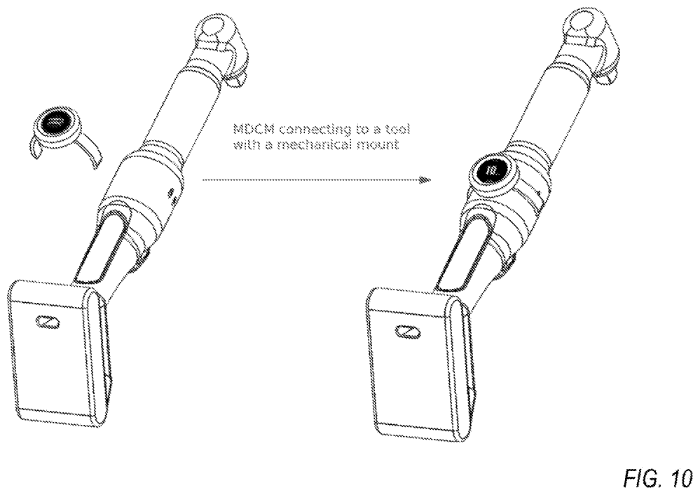

According to an embodiment, a DDCM may be used as a dockable measurement device. For instance, the DDCM may be used in combination with a secondary device with a purpose-built dock. The purpose-built dock may include physical or wireless data transmission and utilize a mechanical attachment, magnetic attachment, docking port, or other means of securing the DDCM to the secondary device. In this way, and as shown in FIG. 10, a user may dock the DDCM on an existing tool to expand or improve the functionality of the existing tool (e.g., a dockable torque wrench or drill, as shown in FIG. 10), remove the DDCM for safe keeping, use one DDCM to interact with many tools, mount the DDCM in a docking port for convenient display placement for visual feedback, and use a wireless connection for remote data collection and display.

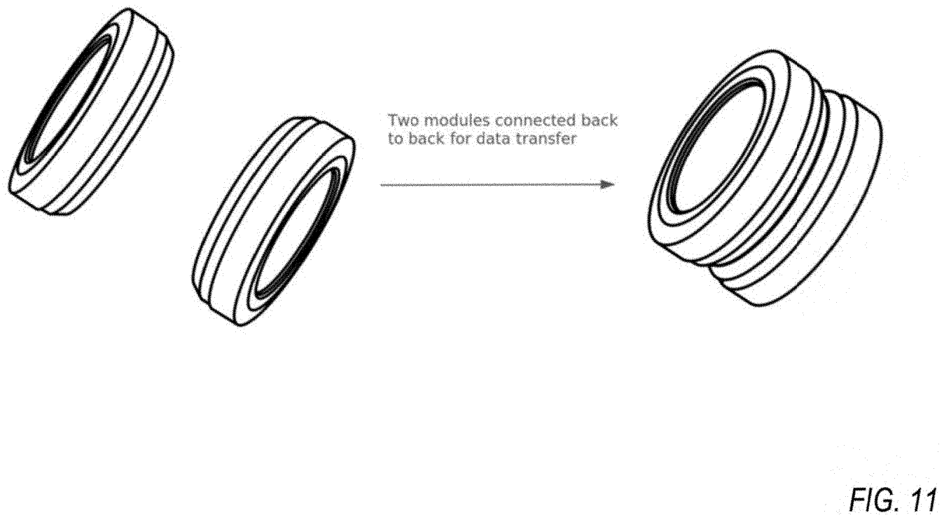

According to an embodiment, docking features of a DDCM are flexible in their implementation. A DDCM can be docked in tools, equipment, and other devices. One or more DDCMs can also be docked together, as shown in FIG. 11. Any number of DDCMs can be connected together with the addition of a multi-port dock, as shown in FIG. 12. In this way, data syncing across many modules is enabled.

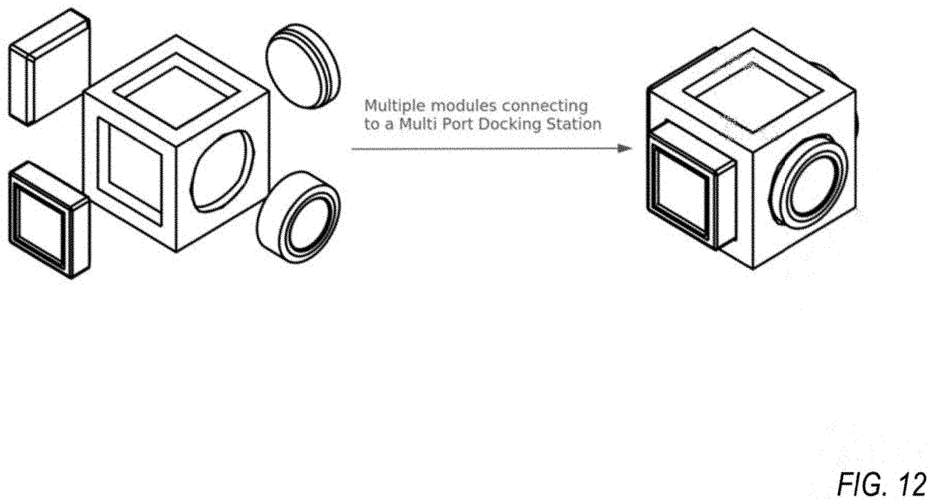

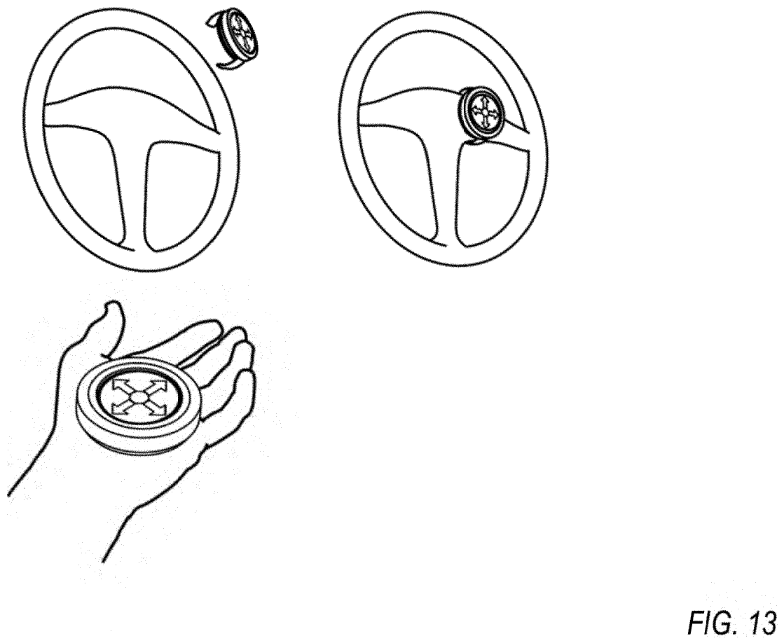

According to an embodiment, a DDCM may be dockable within a vehicular environment by connection with a steering wheel of a vehicle, as shown in FIG. 13. Accordingly, the DDCM may be used to control and/or monitor tire vehicle and/or features thereof, such as motors of the vehicle.

In an embodiment, the DDCM of FIG. 13 can be used to control a vehicle from a remote location or from a locally-docked location within a mechanical subassembly or electronic subassembly of the vehicle.

According to an embodiment, implementation of a DDCM within a specific environment includes a number of interactions. These interactions can include the following: (1) a display of the DDCM, and control thereof, can be changed, updated, and uploaded through wireless communication or hard wires from a third-party device, (2) the display of the DDCM can transfer display information by touch of the display, (3) the DDCM can be activated by one or more sensors, touch of graphics, numbers, gesture, sounds, text or images shown on the display of the DDCM, (4) the display of the DDCM, and graphics displayed thereon, can be memorized and frozen on the screen to calculate, adjust, and make changes or be compared with other objects, and (5) the display of the DDCM can change the graphics, controller menus, and status of the sensors, as well as switch or replace a display using one or mom sensors automatically.

The display of the DDCM can change based on the function of the DDCM the physical location of the DDCM, the proximity to another DDCM or another device (such as a drill), the connecting of the DDCM to another device, or the physical orientation of the DDCM with respect to the ground. Change of the display includes modification of the orientation of the display, modification of the size of the graphics, modification of buttons, modification of the available functions of the device, modification of the positioning of selectable ureas, modification of personalizations of the display, modification of speed of changes of the display, etc.

Exemplary embodiments of control and display by a DDCM will be described with reference to subsequent Figures.

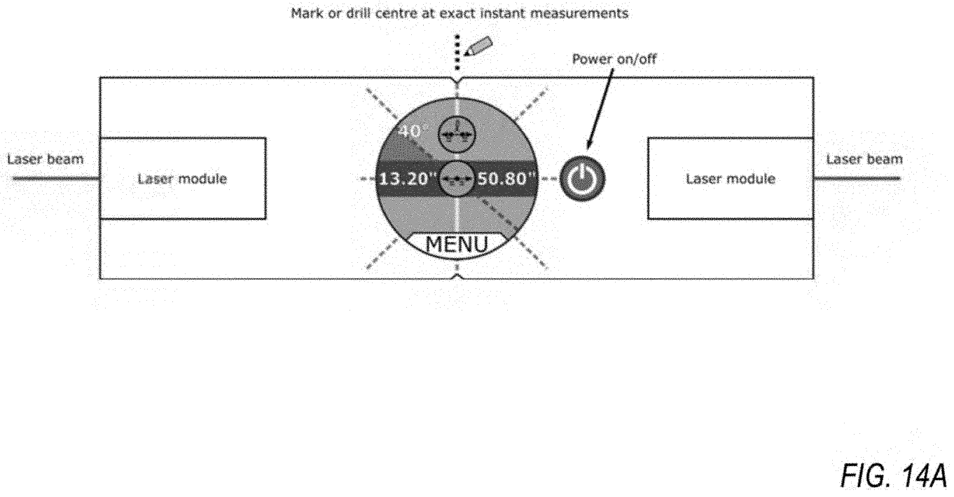

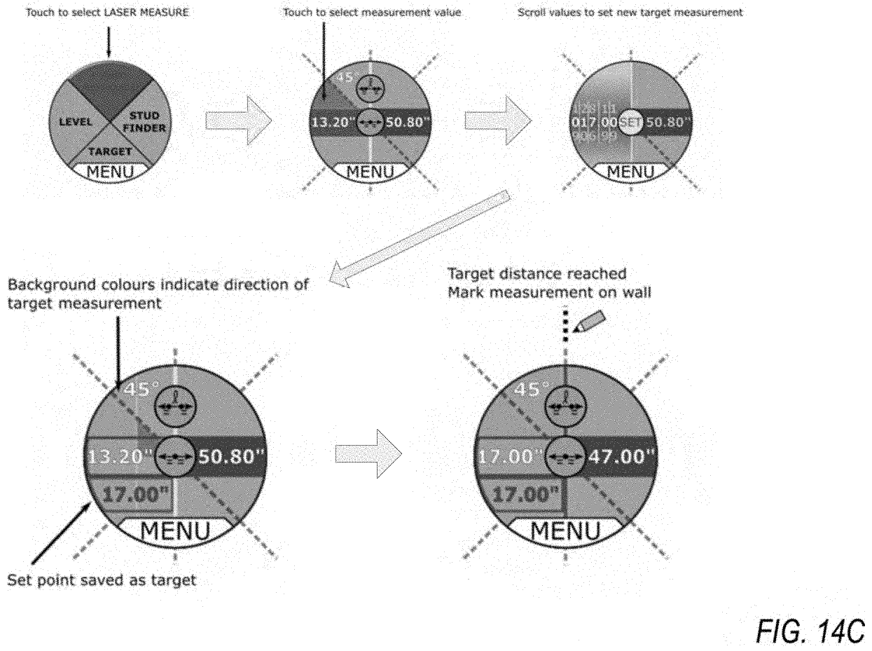

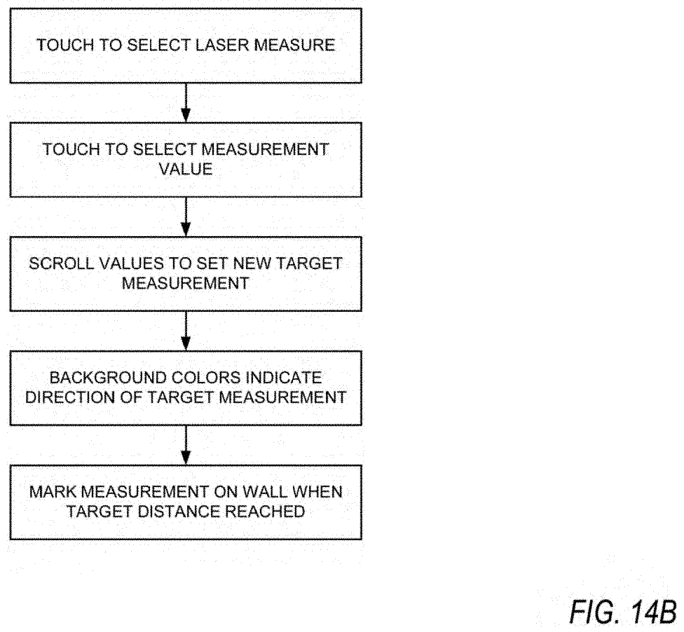

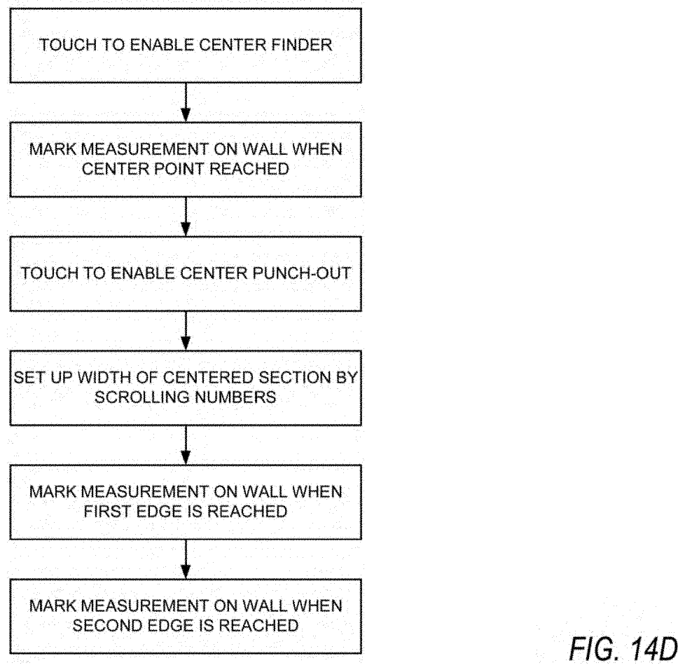

With reference to FIG. 14A through FIG. 14E, implementation of a DDCM as a combination laser and level for marking positions on a wall is illustrated. The DDCM may be docked within a laser device that can be controlled by the DDCM During use, as shown in FIG. 14B and FIG. 14C, interaction with a display of the DDCM allows for user control. First, the display may be touched in order to select laser measure. A measurement value may be selected. A new target measurement may be set by scrolling through measurement values. Having set a new target measurement, the display of the DDCM will then reflect a relative position of the combination laser and level by adjusting a color of a portion of the display of the DDCM When the target distance or measurement is reached, a mark may be made on a wall corresponding to the target measurement. During use of tire combination laser and level in an effort to mark positions on the wall relative to a center, as shown in FIG. 14D and FIG. 14E, interaction with a display of the MDMC allows for user control. First, the display may be touched in order to enable center finder. Based on the lasers, background colors shown on the display indicate a direction of the center point of the wall. Upon reaching the center point, a mark may be made on the wall and the display may again be touched in order to enable center punch-out. A width of a centered section may be set up by scrolling numbers. Upon moving the combination laser and level to a first edge of the centered section, a mark may be made on the wall. Subsequently, upon moving the combination laser and level to a second edge of the centered section, a mark may be made on the wall.

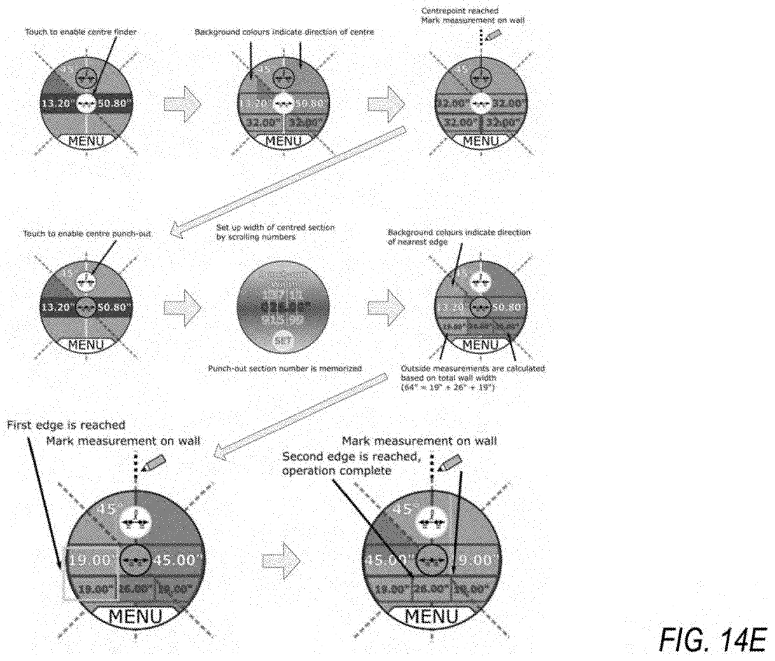

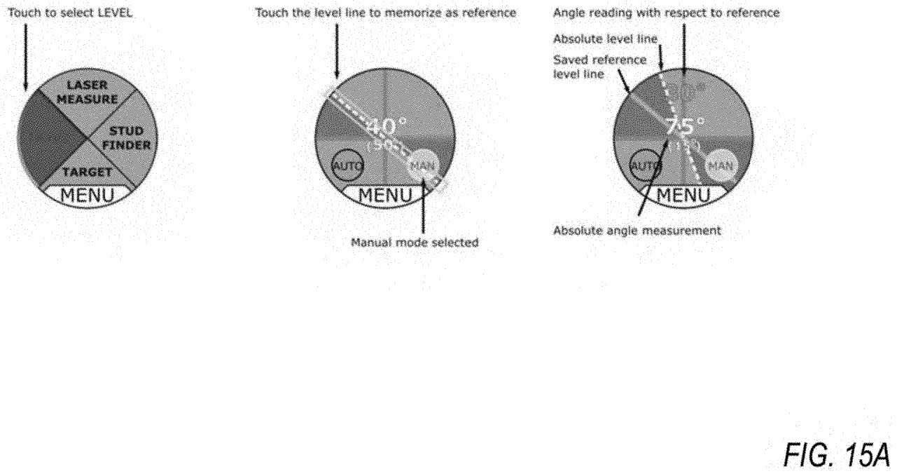

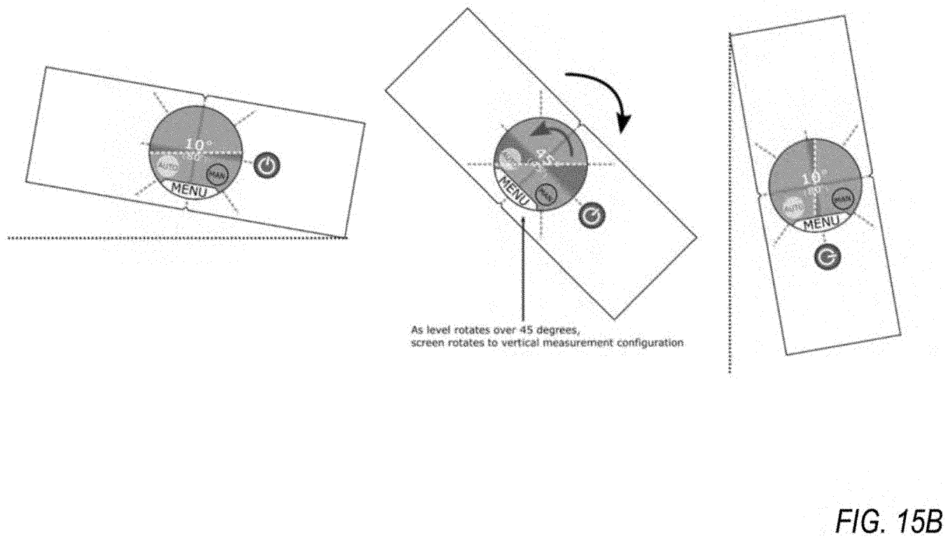

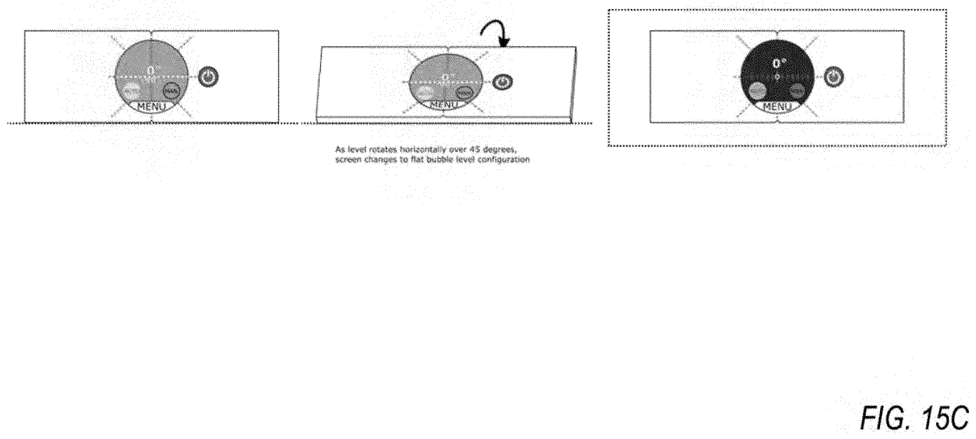

With reference to FIG. 15A through FIG. 15C, implementation of a DDCM as a combination level using one or more inertial measurement units is illustrated The DDCM may provide a 9-axis sensor. During use, as shown in FIG. 15A, interaction with a display of the DDCM allows for user control. First, the display may be touched in order to select level. When in manual mode, a reference line may be established as a level line by touching the display, and the established level line may be memorized. Subsequent angular positions of the combination level may be calculated relative to die established level line. As shown in FIG. 15B, the DDCM may be docked within a level device that can be controlled by the DDCM. In FIG. 15B, it is illustrated that the DDCM can recognize rotation beyond 45° such that displayed graphics of the DDCM rotate in accordance with rotation of the combination level so as to be readable by a user of the combination level. Moreover, as shown in FIG. 15C, when the combination level is rotated horizontally beyond 45°, displayed graphics of the DDCM may be adjusted, accordingly, to display a bubble level that can be used for leveling the surface thereon.

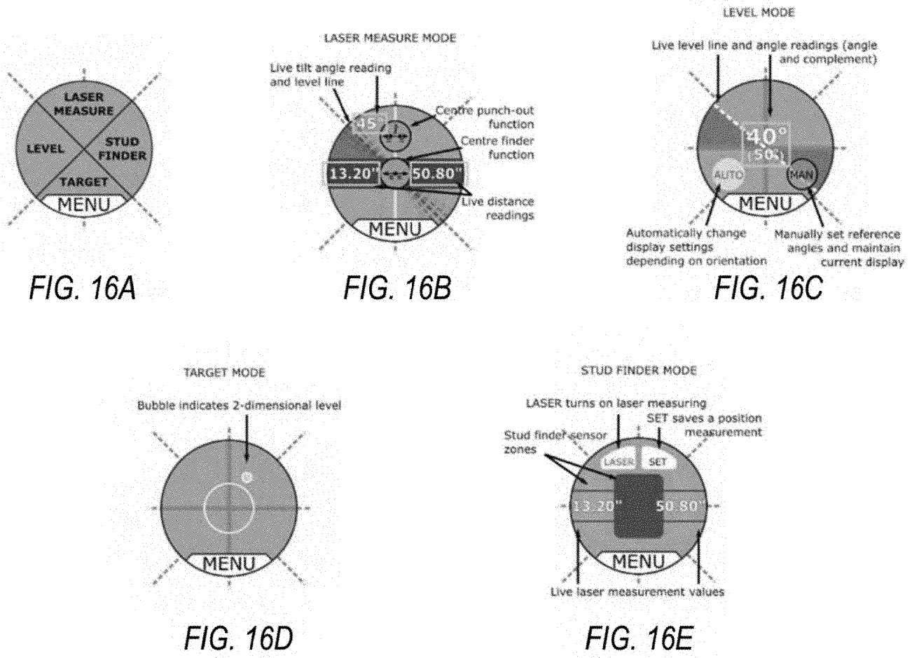

With reference now to FIG. 16A through FIG. 16E, implementation of a DDCM may include exploitation of lasers, inertial measurement units, and antennas. FIG. 16A illustrates a menu of tasks arranged on a display of the DDCM. FIG. 16B illustrates the display of the DDCM when in a laser measure task. FIG. 16C illustrates the display of the DDCM when in a level task. FIG. 16D illustrates the display of the DDCM when in a target mode, wherein a specific location is sought. FIG. 16H illustrates the display of the DDCM when in stud finder task, as will be described in subsequent Figures.

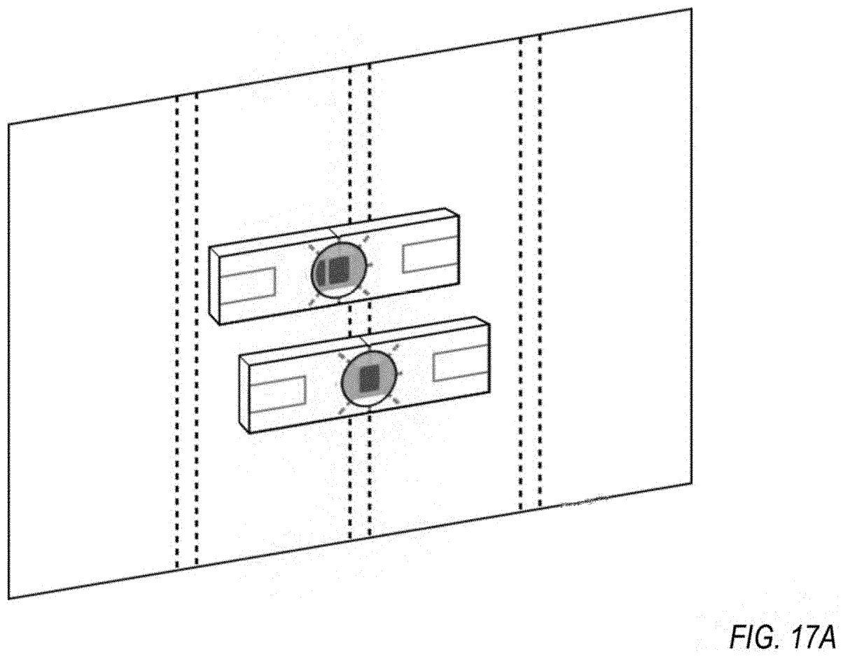

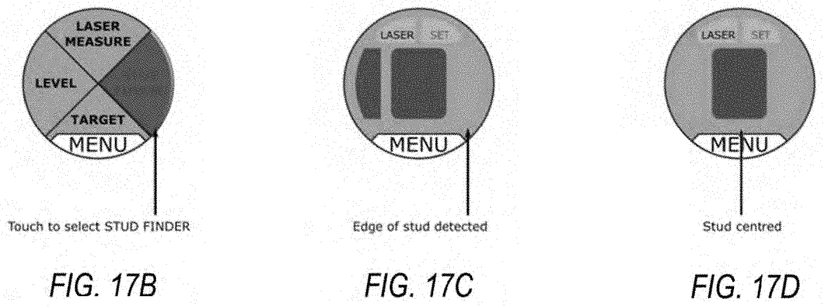

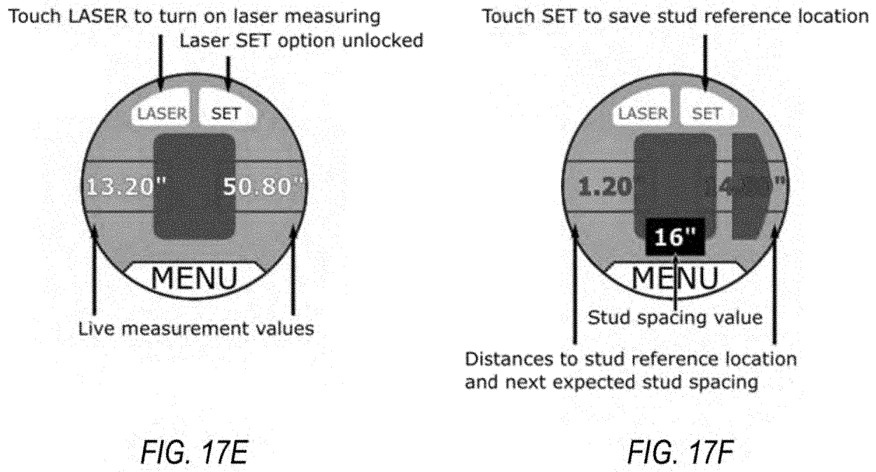

With reference now to FIG. 17A through FIG. 17F, implementation of a DDCM as a stud finder may include exploitation of lasers and antennas. FIG. 17A displays two stud finders in different positions relative to a stud indicated between narrow dashed lines. It can be appreciated that a graphic displayed on a display of the DDCM may change based on a position of the stud finder relative to the stud, and this is shown in FIG. 17A, wherein the lower stud finder is centered within the stud. With reference to FIG. 17B through FIG. 17F, methods of the DDCM as a stud finder are shown, wherein graphics displayed on the display of the DDCM reflect values of sensors therein, for instance. During use, as first shown in FIG. 17B, interaction with the display of the DDCM allows for user control. The display may be touched in order to select stud finder. Then, an edge of a stud may be detected on a right side of the stud finder, as illustrated in FIG. 17C. Having maneuvered the stud finder into a centered position relative to the stud, the display of the DDCM reflects this positioning, as shown in FIG. 17D. In an embodiment, the position of the stud may be recorded and saved such that adjacent studs may be easily identified. For instance, as in FIG. 17E, laser measuring can be initiated in order to determine distances to adjacent walls, thus ‘locking in’ a position of die stud as a first stud. Appreciating studs are typically arranged every 16 inches within a wall, a second stud may be found using the first stud as a reference and distance values to the first stud, as shown in FIG. 17F.

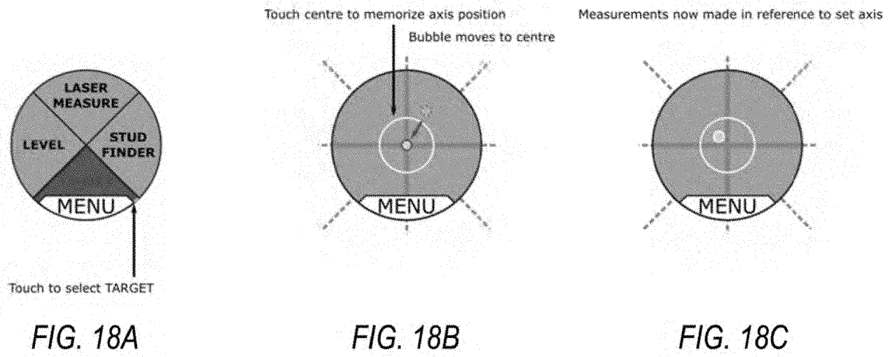

With reference now to FIG. 18A through FIG. 18C, implementation of a DDCM may include exploitation of multiple inertial measurement units for target tasks, wherein a position may be memorized and subsequent measurements may be made relative thereto. During use, as first shown in FIG. 18A, interaction with a display of the DDCM allows for user control. The display may be touched m order to select target. Then, when the DDCM is in a desired position, the display may again be touched in order to memorize the present position of the DDCM, as shown in FIG. 18B. Subsequent measurements may then be made with reference to the memorized position, as shown in FIG. 18C.

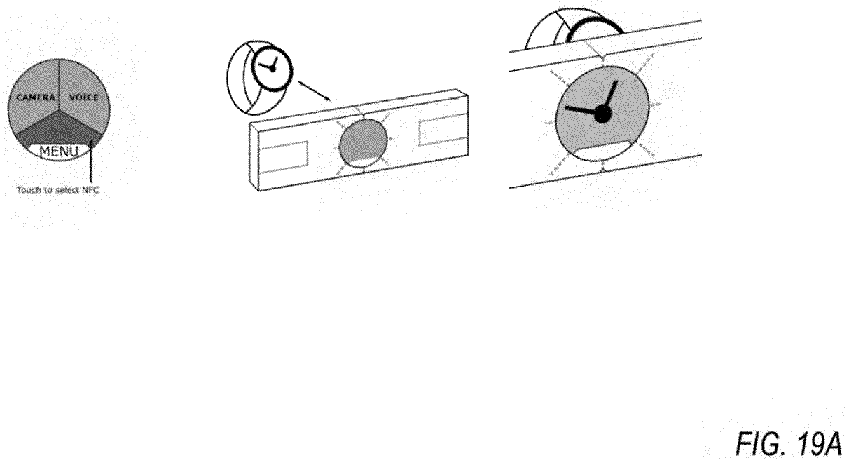

According to an embodiment, implementation of a DDCM may include exploitation of antennas in order to detect a presence of a secondary device and, subsequently, control and display specific menus on a display of the DDCM based on the detected secondary device. With reference now to FIG. 19A and FIG. 19B, the secondary device may be a wrist watch. To detect the presence of the wrist watch, a user may navigate to a near field communication task within the display of the DDCM. Upon being positioned proximate the wrist watch, a display of the DDCM automatically updates the graphics being displayed based on the type of secondary device.

In an embodiment, as in FIG. 19A, the DDCM detects a bracelet via, among others, near field communication, tags, mechanical, or magnetic form. The DDCM may then connect to a secondary device that has other sensors, thereby connecting to the assembly of the bracelet and the DDCM. In this way, a combination of the DDCM and two devices is possible.

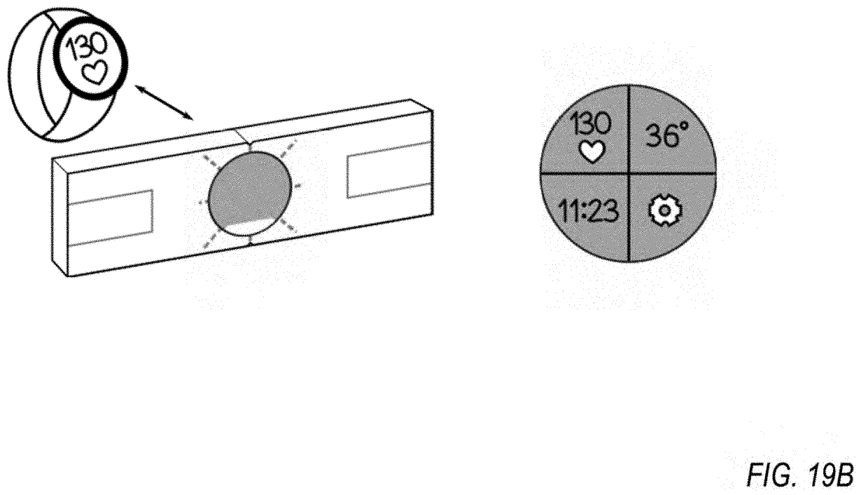

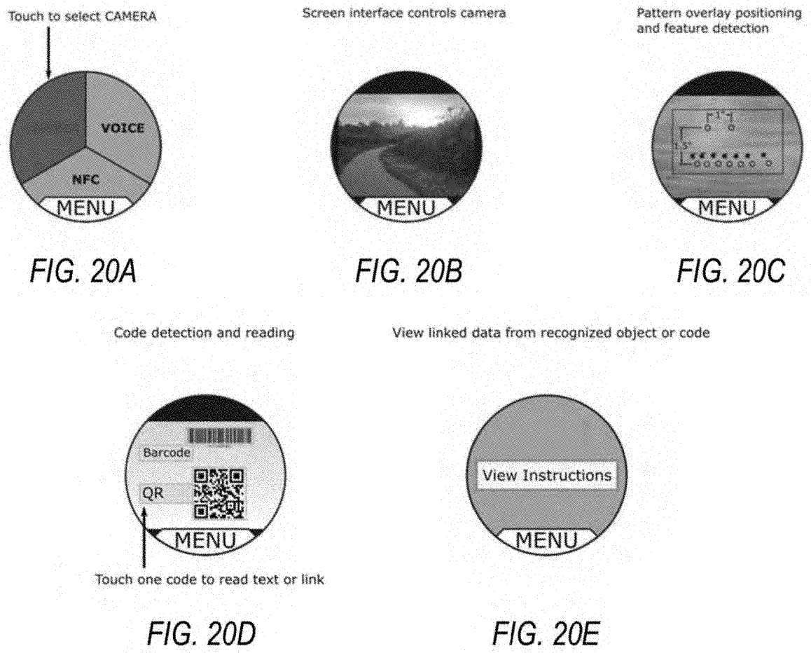

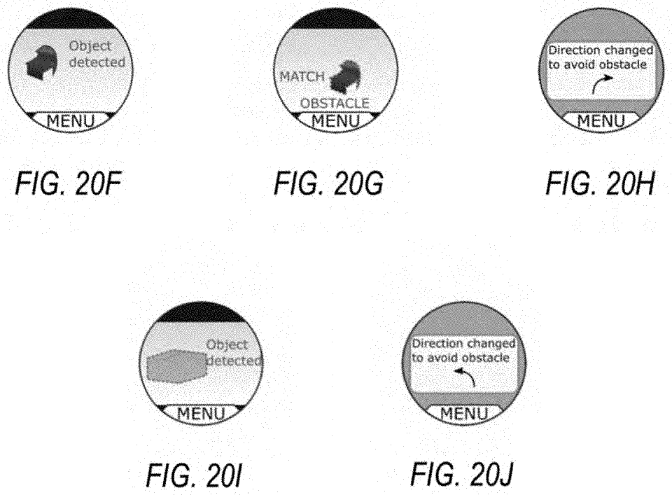

With reference to FIG. 20A through FIG. 20J, implementation of a DDCM may include exploitation of a camera(s) and other sensor(s) in order to control and display matching, tracking, and comparing of visual objects. During use, as first shown in FIG. 20A, interaction with a display of the DDCM allows for user control First, the display may be touched in order to enter a camera task. As in FIG. 20B, an output of a camera(s) of the DDCM may be displayed on the display thereof. In an embodiment, as in FIG. 20C, an object within the cameras field of view may include patterns and features that can be detected. This can include, as in FIG. 20D, a barcode and/or a QR code related to a product. As shown in FIG. 20E, the barcode and or the QR code related to the product observed in FIG. 20D can be linked to a product manual or other instructions relevant to the component.

In an embodiment, the camera(s) of the DDCM may employ computer vision, image processing, and artificial intelligence. The camera(s) of the DDCM may be exploited for object detection, in an example. For instance, as in FIG. 20F and FIG. 20G, a contour of a virtual object may be evaluated in view of an object within the field of view of the camera to determine a match. The match may be determined upon comparison of the object of a specific shape or form with reference images stored in internal memory or external memory. In an embodiment, upon matching the object within the field of view of the camera to a reference object, a status of the sensors of the DDCM and or a sequence of actions performed thereby can be adjusted based on the identity of the obstacle. In an embodiment, upon matching the object within the field of view of the camera to a virtual object, object specifications may be displayed on the display of the DDCM. In another embodiment, upon matching the object within the field of view of the camera to a virtual object, a direction of travel may be changed in order to avoid the detected obstacle, as in FIG. 20H.

In an embodiment, lasers controlled by the DDCM may be used in concert with pattern overlay and camera recognition to trace patterns onto physical medium. A pattern may be drawn on the medium and a camera may detect completed sections, thereby tracking points on medium to keep the pattern aligned. Dual-laser measurements may be sued to transfer a physical pattern to a digital copy. As the DDCM is moved to maintain the pattern with a circle, lasers w ill automatically capture the path.

Similarly, in FIG. 20I, a graphic representation of a motion sensors such as a camera, inertial measurement unit, and others, a path of a stored shape can be traced and matched in order to detect an object. Upon detecting the object and as an obstacle, the obstacle can be avoided, as in FIG. 20J.

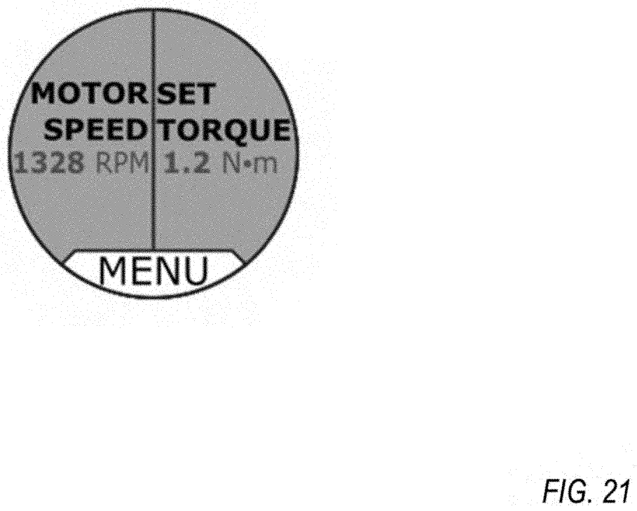

With reference to FIG. 21, implementation of a DDCM may include control of and display of motor speeds and torques on one or more secondary devices.

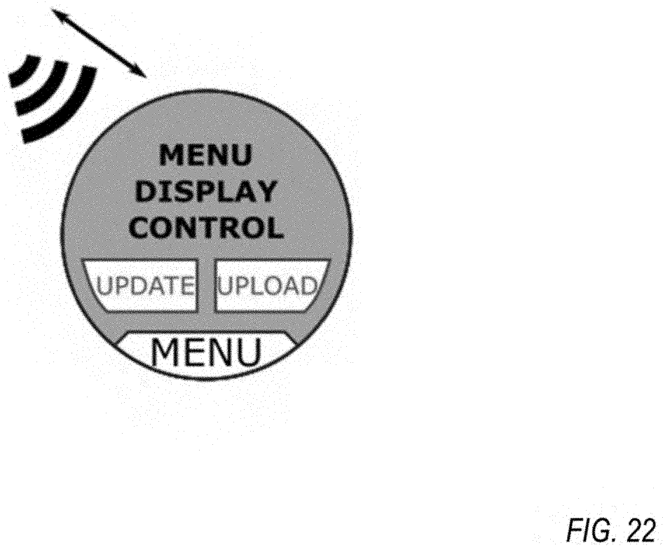

With reference to FIG. 22, implementation of a DDCM may include wireless communication or hard wired connection in order to upload and update the controller and display of the DDCM.

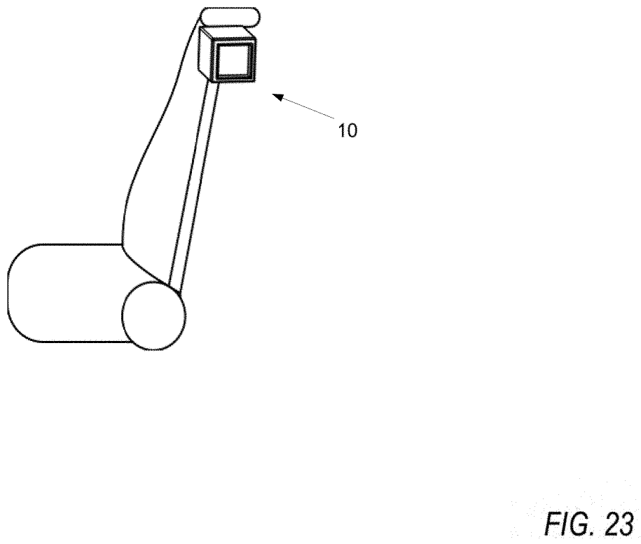

With reference to FIG. 23, implementation of a DDCM 10 may include application to control of a vacuum cleaner. In an embodiment, the DDCM 10 of FIG. 23 can be a dockable device or can be physically integrated with the vacuum cleaner. The DDCM 10 can be configured to control functionalities of the vacuum cleaner.

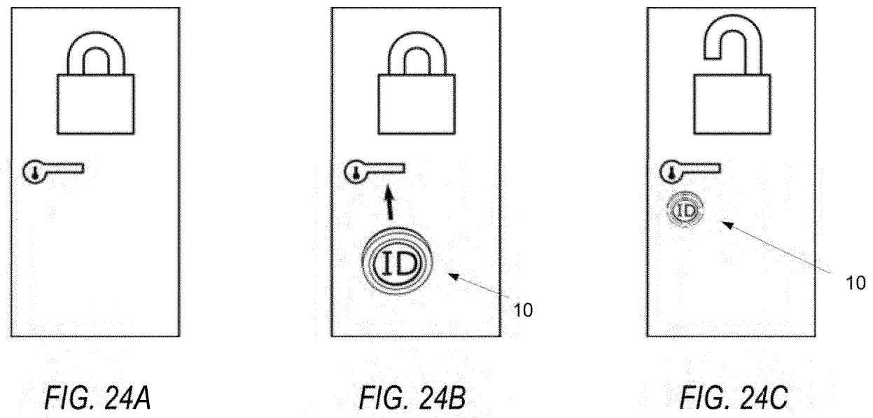

With reference to FIG. 24A through 24C, implementation of a DDCM 10 may include application to an electric lock within a door. In an embodiment, the DDCM 10 of FIG. 23B and FIG. 24C can be a dockable device or can be physically integrated with the door having the electric lock. The DDCM 10 can be configured to control an access status of the electric lock.

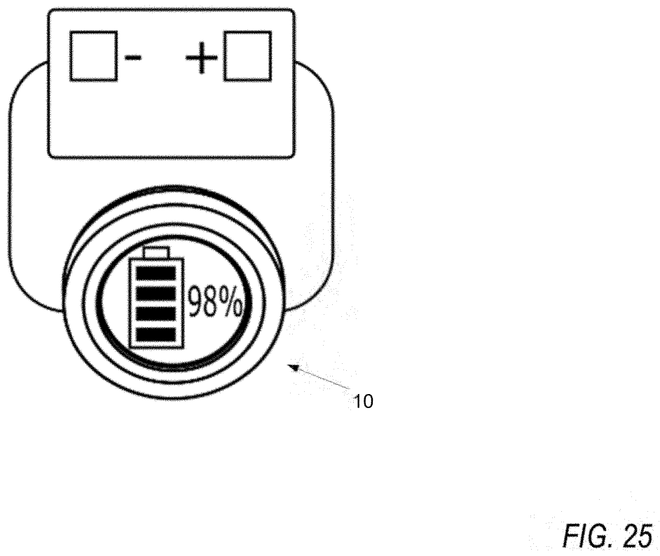

With reference to FIG. 25, implementation of a DDCM 10 may include application within a secondary device. In an embodiment the DDCM 10 of FIG. 25 can be a dockable device or can be physically integrated with the secondary device. The DDCM 10 can be configured to control a display or batter inside the secondary device.

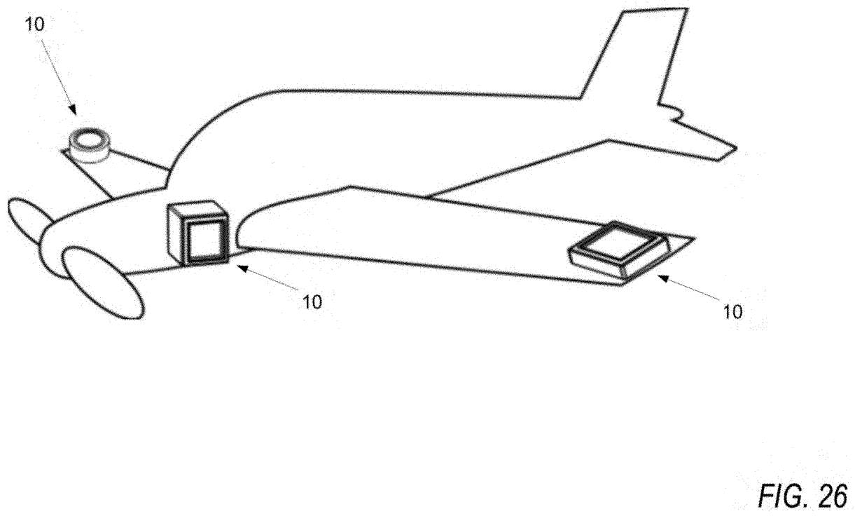

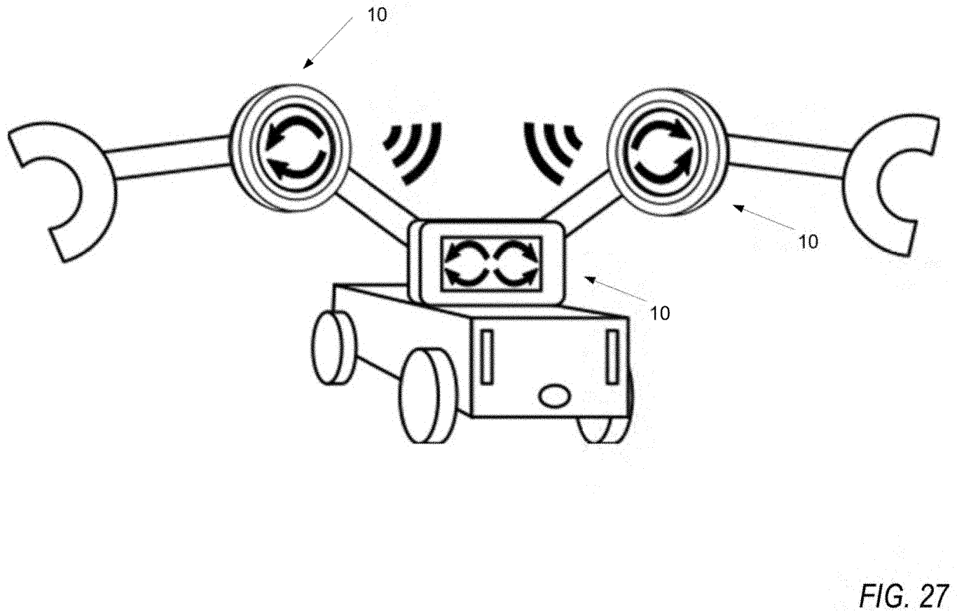

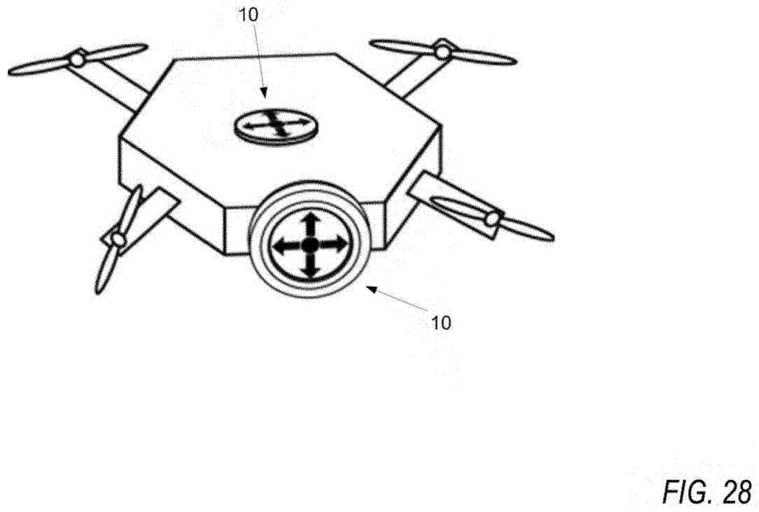

With reference to FIG. 26, implementation of a DDCM 10 may include application to aviation. In an embodiment, the DDCM 10 of FIG. 26 can be a dockable device or can be physically integrated with aspects of an airplane, for instance. A plurality of DDCMs 10 can be disposed about the airplane and configured to control functions of each region of the airplane.

With reference to FIG. 27, implementation of a DDCM 10 may include robotic applications. In an embodiment, the DDCM 10 of FIG. 27 can be a dockable device or can be physically integrated with aspects of the robotic application. A plurality of DDCMs 10 can be disposed about a robot, for instance, and configured to control functions of each region of the robot.

With reference to FIG. 28, implementation of a DDCM 10 may include application to unmanned aircraft, such as drones. In an embodiment, the DDCM of 10 FIG. 28 can be a dockable device or can be physically integrated with aspects of the unmanned aircraft. A plurality of DDCMs 10 can be disposed about the unmanned aircraft and configured to control functions of each region of the unmanned aircraft.

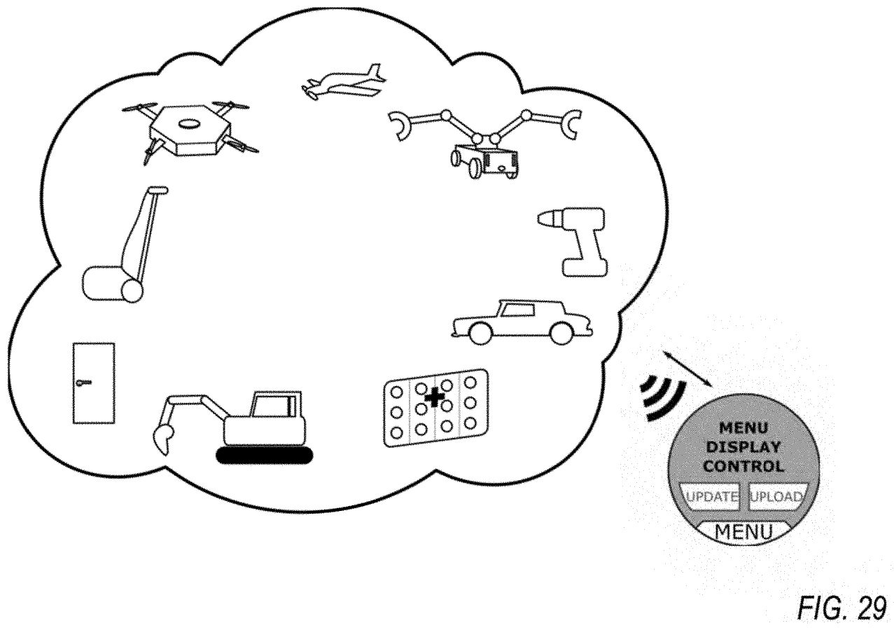

With reference to FIG. 29, implementation of a DDCM may include application software that can be stored in local memory and or uploaded from a secondary memory system such as a cloud-computing environment. For instance, complex and data demanding streaming application software, where data storage is insufficient local to the DDCM, can be run directly from the cloud-computing environment to the DDCM microprocessor. Exemplary applications are as described above and include vision processing, data analysis, and other memory and large processing power needs. The DDCM microprocessor can be configured to received data already processed inside the cloud-computing environment and to implement the final display and commands on the docked device.

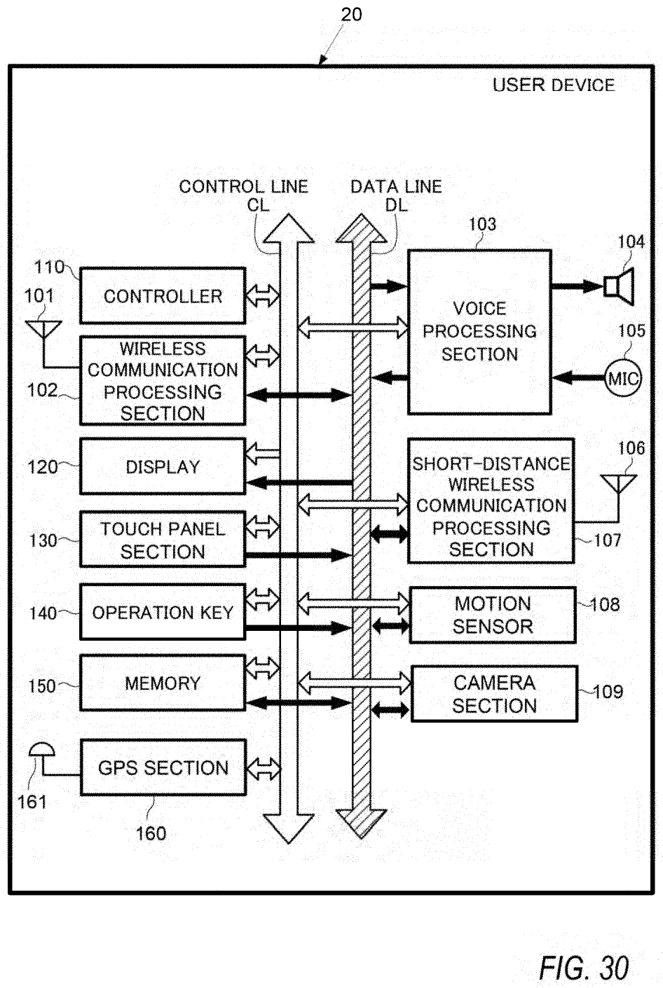

According to an embodiment, a DDCM of the present disclosure may include a hardware configuration similar to that of FIG. 30, which provides a detailed block diagram of an exemplary user device 20. In certain embodiments, user device 20 may be a smartphone, though it can be appreciated that the user device 20 may be the DDCM. Moreover, the skilled artisan will appreciate that the features described herein may be adapted to be implemented on other devices (e.g., a laptop, a tablet, a server, an e-reader, a camera, a navigation device, etc.). The exemplary user device 20 of FIG. 30 includes a controller 110 and a wireless communication processor 102 connected to an antenna 101. A speaker 104 and a microphone 105 are connected to a voice processor 103.

The controller 110 may include one or more Central Processing Units (CPUs), and may control each element in the user device 20 to perform functions related to communication control, audio signal processing, control for the audio signal processing, still and moving image processing and control, and other kinds of signal processing. The controller 110 may perform these functions by executing instructions stored in a memory 150. Alternatively or in addition to the local storage of the memory 150, the functions may be executed using instructions stored on an external device accessed on a network or on a non-transitory computer readable medium. As described above with reference to the Figures, the controller 110 may execute instructions allowing the controller 110 to function as a display control unit, an operation management unit, and the like.

The memory 150 is an example of a storage unit and includes but is not limited to Read Only Memory (ROM), Random Access Memory (RAM), or a memory array including a combination of volatile and non-volatile memory units. The memory 150 may be utilized as working memory by the controller 110 while executing the processes and algorithms of the present disclosure. Additionally, the memory 150 may be used tor long-term storage, e.g., of image data and information related thereto.

The user device 20 includes a control line CL and data line DL as internal communication bus lines. Control data to/from the controller 110 may be transmitted through the control line CL. The data line DL may be used for transmission of voice data, display data, etc.

The antenna 101 transmits/receives electromagnetic wave signals between base stations for performing radio-based communication, such as the various forms of cellular telephone communication. The wireless communication processor 102 controls the communication performed between the user device 20 and other external devices via the antenna 101. For example, the wireless communication processor 102 may control communication between base stations for cellular phone communication.

The speaker 104 emits an audio signal corresponding to audio data supplied from the voice processor 103. The microphone 105 detects surrounding audio and converts the detected audio into an audio signal. The audio signal may then be output to the voice processor 103 for further processing. The voice processor 103 demodulates and/or decodes the audio data read from the memory 150 or audio data received by the wireless communication processor 102 and/or a short-distance wireless communication processor 107. Additionally, the voice processor 103 may decode audio signals obtained by the microphone 105.

The exemplary user device 20 may also include a display 120, a touch panel 130, an operation key 140, and a short-distance communication processor 107 connected to an antenna 106. The display 120 may be a Liquid Crystal Display (LCD), an organic electroluminescence display panel, or another display screen technology. In addition to displaying still and moving image data, the display 120 may display operational inputs, such as numbers or icons which may be used for control of the user device 20. The display 120 may additionally display a GUI for a user to control aspects of the user device 20 and/or other devices. Further, the display 120 may display characters and images received by the user device 20 and or stored in the memory 150 or accessed from an external device on a network. For example, the user device 20 may access a network such as the Internet and display text and/or images transmuted from a Web server.

The touch panel 130 may include a physical touch panel display screen and a touch panel driver. The touch panel 130 may include one or more touch sensors for detecting an input operation on an operation surface of the touch panel display screen. The touch panel 130 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 130 may detect when the stylus approaches/contacts the operation surface of the touch panel display (similar to the case in which a finger is used for the touch operation).

One or more of the display 120 and the touch panel 130 are examples of the display described above.

In certain aspects of the present disclosure, the touch panel 130 may be disposed adjacent to the display 120 (e.g., laminated) or may be formed integrally with the display 120. For simplicity, the present disclosure assumes the touch panel 130 is formed integrally with the display 120 and therefore, examples discussed herein may describe touch operations being performed on the surface of the display 120 rather than the touch panel 130. However, the skilled artisan will appreciate that this is not limiting.

For simplicity, the present disclosure assumes the touch panel 130 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 130 may include transparent electrode touch sensors arranged in the X-Y direction on the surface of transparent sensor glass.

The touch panel driver may be included in the touch panel 130 for control processing related to the touch panel 130, such as scanning control For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 130 may detect a position of a user's finger around an edge of the display panel 120 (e.g., gripping a protective case that surrounds the display/touch panel). Signals may be transmitted by the touch panel driver, e.g., in response to a detection of a touch operation, in response to a query from another element based on timed data exchange, etc.

The touch panel 130 and the display 120 may be surrounded by a protective casing, which may also enclose the other elements included in the user device 20. In certain embodiments, a position of the user's fingers on the protective casing (but not directly on the surface of the display 120) may be detected by the touch panel 130 sensors. Accordingly, the controller 110 may perform display control processing described herein based on the detected position of the user's fingers gripping the casing. For example, an element in an interface may be moved to a new location within the interface (e.g., closer to one or more of the fingers) based on the detected finger position.

Further, in certain embodiments, the controller 110 may be configured to detect which hand is holding the user device 20, based on the detected finger position. For example, the touch panel 130 sensors may detect a plurality of fingers on the left side of the user device 20 (e.g., on an edge of the display 120 or on the protective casing), and detect a single finger on the right side of the user device 20. In this exemplary scenario, the controller 110 may determine that the user is holding the user device 20 with his/her right hand because the detected grip pattern corresponds to an expected pattern when the user device 20 is held only with the right hand.

The operation key 140 may include one or more buttons or similar external control elements, which may generate an operation signal based on a detected input by the user. In addition to outputs from the touch panel 130, these operation signals may be supplied to the controller 110 for performing related processing and control. In certain aspects of the present disclosure, the processing and/or functions associated with external buttons and the like may be performed by the controller 110 in response to an input operation on the touch panel 130 display screen rather than the external button, key. etc. In this way, external buttons on the user device 20 may be eliminated in lieu of performing inputs via touch operations, thereby improving water-tightness.

The antenna 106 may transmit/receive electromagnetic wave signals to/from other external apparatuses, and the short-distance wireless communication processor 107 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 107.

The user device 20 may include a motion sensor 108. The motion sensor 108 may detect features of motion (i.e., one or more movements) of the user device 20 and may be an inertial measurement unit, in an example. For example, the motion sensor 108 may include an accelerometer to detect acceleration, a gyroscope to detect angular velocity, a geomagnetic sensor to detect direction, a geo-location sensor to detect location, etc., or a combination thereof to detect motion of the user device 20. In certain embodiments, the motion sensor 108 may generate a detection signal that includes data representing the detected motion. For example, the motion sensor 108 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and or acceleration of the motion (instantaneous and-or temporal), or other motion features. The detected motion features may be included in the generated detection signal. The detection signal may be transmitted, e.g., to the controller 110, whereby further processing may be performed based on data included in the detection signal. The motion sensor 108 can work in conjunction with a Global Positioning System (GPS) section 160. The GPS section 160 detects the present position of the terminal device 100. The information of the present position detected by the GPS section 160 is transmitted to the controller 110. An antenna 161 is connected to the GPS section 160 for receiving and transmitting signals to and from a GPS satellite.

The user device 20 may include a camera section 109, which includes a lens and shutter for capturing photographs of the surroundings around the user device 20. In an embodiment, the camera section 109 captures surroundings of an opposite side of the user device 20 from the user. The images of the captured photographs can be displayed on the display panel 120. A memory section saves the captured photographs. The memory section may reside within the camera section 109 or it may be part of the memory 150. The camera section 109 can be a separate feature attached to the user device 20 or it can be a built-in camera feature.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An apparatus, comprising
a display;
an antenna, and
processing circuitry configured to
receive, via the antenna, a near-field communication data packet from an antenna of a secondary device, the near-field communication data packet including information regarding a functional type of the secondary device, and
update graphics of the display based on the functional type of the secondary device.
